(19) United States
(12) Patent Application Publication
(10) Pub. No.: US 2008/0175964 A1
(43) Pub. Date: Jul. 24, 2008

(54) Method for making bleached soy fiber

(75) Inventors: Kumar Padmanabhan, Lawrenceville, NJ (US); Loren W. Larson, Stanchfield, MN (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SunOpta Inc., Norval (CA)

(21) Appl. No.: 11/655,012

(22) Filed: Jan. 18, 2007

(51) Int. Cl. A23L 1/277

(52) U.S. Cl. 426/254; 426/261

(57) ABSTRACT

Disclosed is a process for preparing bleached soy fiber suitable for human consumption. The soy fiber is extremely white and has a very high percentage of total dietary fiber with a low concentration of non-fiber components, such as starch, fat, protein and lignin.

### BACKGROUND OF THE INVENTION

A recent American Dietetic Association position paper reported that most Americans do not eat the recommended intake of 20 grams to 35 grams of fiber per day. In fact, the mean fiber intake for Americans is about half that at 14-15 grams a day.

Consumption of dietary fibers has beneficial health effects including, lowering blood cholesterol levels, normalizing blood glucose and insulin levels, promoting normal Taxation. Furthermore, fiber-rich meals are processed more slowly, which promotes earlier satiety, and are frequently less calorically dense and lower in fat and added sugars. A fiber-rich diet is lower in energy density, often has a lower fat content, is larger in volume, and is richer in micronutrients, all of which have beneficial health effects.

Therefore, a high fiber diet can have a significant impact on the prevention and treatment of disorders, such as, obesity, cardiovascular disease, and type 2 diabetes, as well as constipation. However, the preparation and commercialization of fiber as a food additive requires the development of a formulation that is acceptable in terms of nutritional index, color, yield, and ease of preparation.

### SUMMARY OF THE INVENTION

The present invention is directed to a process for preparing bleached soy fiber suitable for human and animal consumption. The soy fiber of the present invention is extremely white and has a high percentage of total dietary fiber with a low concentration of non-fibrous or non-cellulosic components, such as but not limited to, gums, pectins, fat, lignin, proteins and starch.

In one embodiment, the method comprises combining soy hulls with water, an amount of peroxide radical donor effective to bleach the soy hulls and a pH regulating amount of buffer, to form a composition having a pH from about 5.5 to about 8.5. The method comprises a second step of isolating bleached soy fiber from the composition to give a yield of between about 10 and about 50% of bleached soy fiber. The bleached soy fiber can be optionally dewatered, optionally rinsed, optionally dried and optionally ground In a preferred embodiment, it is desirable to dewater, rinse, dry and grind the material to extend shelf life, eliminate residual chemicals, undesirable flavors and also improve texture.

In another embodiment, the process for making a bleached soy fiber comprises combining soy hulls with water and a pH regulating amount of buffer to form a composition having a pH from about 5.5 to about 8.5. The method comprises a second step of adding an amount of peroxide radical donor, effective to bleach the soy hulls to the composition. The method comprises a third step of isolating bleached soy fiber from the composition to give a yield of between 10 and 50% of bleached soy fiber. The bleached soy fiber can be optionally dewatered, rinsed, dried and ground.

In yet another embodiment, the process for making bleached soy fiber comprises combining between about 1 to about 50 parts by weight soy hulls with about 100 parts by weight water, with an amount of peroxide radical donor effective to bleach the soy hulls and a pH regulating amount buffer, to form a composition having a pH from about 5.5 to about 8.5. The method comprises a second step of isolating bleached soy fiber from the composition. The bleached soy fiber can be optionally dewatered, rinsed, dried and ground.

The soy fibers, in general, can be used as a food additive in, for example, bakery products, such as, bread without causing any signification discoloration of the bread. Further, the present invention provides a method of making a variety of soy fiber ingredients (both organic and inorganic) from soy hulls using a process that produces a high total dietary fiber and requires low chemical load and low costs for effluent treatments.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of a batch process.

FIG. 2 is an illustration of a continuous process.

FIG. 3 is a graph showing brightness L of a bleached soy fiber slurry versus total residence time, produced according to Example 1.

FIG. 4 is a graph showing color b of a bleached soy fiber slurry versus total residence time, produced according to Example 1.

### DETAILED DESCRIPTION OF THE INVENTION

A description of preferred embodiments of the invention follows.

The present invention provides methods of bleaching and digesting soy hulls at a controlled pH to produce bleached soy fiber with a high total dietary fiber content, and a low non-fibrous or non-cellulosic material content.

In the methods of the present invention, in general, the soy hulls are bleached and the non-fibrous material is digested in one-step without the need for additional processing, such as, isolation or purification of the fiber between steps. That is, the methods of the present invention involve a one-step process which both bleaches the soy fiber and digests non-fibrous or non-cellulosic materials from the soy fiber. As defined herein, “digestion” is intended to mean a process which removes the non-fibrous or non-cellulosic material from soy hulls to yield a product that is concentrated in soy fiber or is essentially only soy fiber. During the process of digestion, there may or may not be a chemical change in the soy fiber undergoing digestion. As defined herein, “bleached” is intended to mean a process that whitens the soy fiber compared to its starting material. The term “bleached” also refers to the resultant soy fiber produced according to the processes set forth herein that has been whitened compared to its starting material.

The bleaching and digestion process can be carried out on a batch or continuous basis, as will be described in detail below. The term “batch” is intended to mean a process where the entire composition undergoes bleaching and digestion for a period of time that is sufficient for completion of the reaction, without the addition of new raw materials. The term “continuous” is intended to mean a process where the composition undergoing bleaching and digestion is continuously feed into the reactor and moved through the reactor vessel or a series of reaction vessels for a period of time that is sufficient to achieve the degree of bleaching that is desired. In the continuous process, the degree of bleaching and digestion is progressive as the soy fiber is passed through the reactor vessel or series of vessels.

A combination of batch and continuous processing is referred to herein as a “semicontinuous” process.

For batch processing of soy hulls, a composition of soy hulls, peroxide radical donor, buffer and water are added to a first tank and allowed to react with optional agitation until the desired degree of bleaching and digestion is achieved. The bleached soy fiber composition can then be further processed to rinse and dewater the fiber. The fiber can then be dried and optionally ground to desired size.

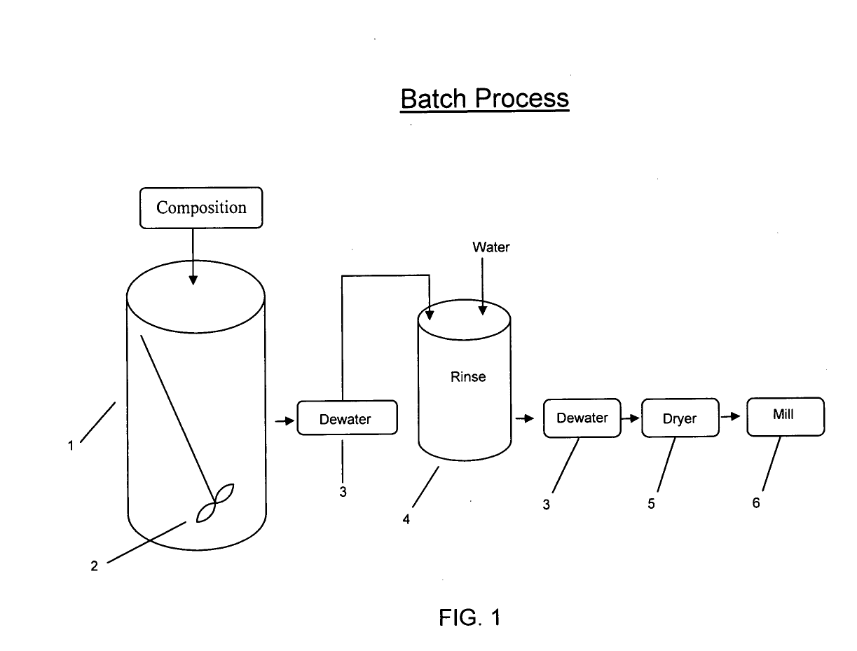

FIG. 1 illustrates an embodiment of the methods of the invention which is carried out in a batch process. The soy hulls can be added together with the water and chemicals. To ensure proper mixing, water can be added prior to, or along with the hulls and chemicals. Since it is advisable to not subject the soy hulls to extreme pH conditions, the buffering reagents should be added together, either along with the hulls or prior to hulls addition. Peroxide ion donor should be added along with, or after the addition of soy hulls. All are placed in reactor 1 having a stirring element 2. The digestion and bleaching process continues in reactor 1 until the desired level of bleaching and digestion is achieved. The bleached and digested fiber is isolated by a series of rinse and dewatering steps. The fiber is dewatered using a centrifuge 3 or other device for separating the fiber from the effluent. The fiber is then rinsed in rinse tank 4 to remove chemical residue from the digestion and bleaching step. The dewatered fiber can optionally be dried in dryer 5.

Suitable dewatering equipment includes centrifugation equipment like a centrifuge or a decanter, filtering equipment like a belt filter, squeezing equipment like a belt press. Suitable drying equipment includes box dryers, flash dryers, drum dryers, spray dryers, and freeze dryers, which will be obvious to anyone skilled in the art.

Optionally, the dried fiber can be ground in a mill 6 to yield a fiber of desired size depending upon the end use for the soy fiber.

Although FIG. 1 shows one reactor, it should be noted that the batch process can be processed using multiple reactors where the composition is passed between two or more reactors.

Bleaching and digestion of soy hulls can also be carried out on a continuous basis. For continuous processing, the composition of soy hulls, water, peroxide radical donor and buffer is added to a first reaction vessel on a continuous basis until a desired level of the composition is established in the reaction vessel. Once the desired level is established, the composition is transferred to a second reaction vessel to continue bleaching and digestion. A continuous supply of the composition of soy hulls, water, peroxide radical donor and buffer are added to the first reaction vessel to maintain the desired level. Once the desired level is reached in the second reaction vessel, the composition is transferred to a third vessel, and so on, until the desired level of bleaching and digestion is reached. The number of reaction vessels utilized in the continuous process will be apparent to the skilled person based upon the capacity of the reaction vessels, the rate of flow of the composition, and the degree of bleaching desired. The composition comprising the bleached and digested soy hulls (soy fiber), is then removed from the reaction vessel (or tank) and isolated. The soy fiber is dewatered and rinsed as described above for the batch process. The bleached soy fiber can be optionally dried and optionally dewatered as described above for the batch process. The desired level of composition in the tank is about 50%, about 60%, about 70%, about 80%, about 85% or about 90% of the tank capacity.

In an embodiment of the continuous process, it is desirable to use a single reaction vessel for the bleaching and digestion, where the reaction composition flows through the reactor for a period of time that is sufficient to achieve the desired degree of bleaching.

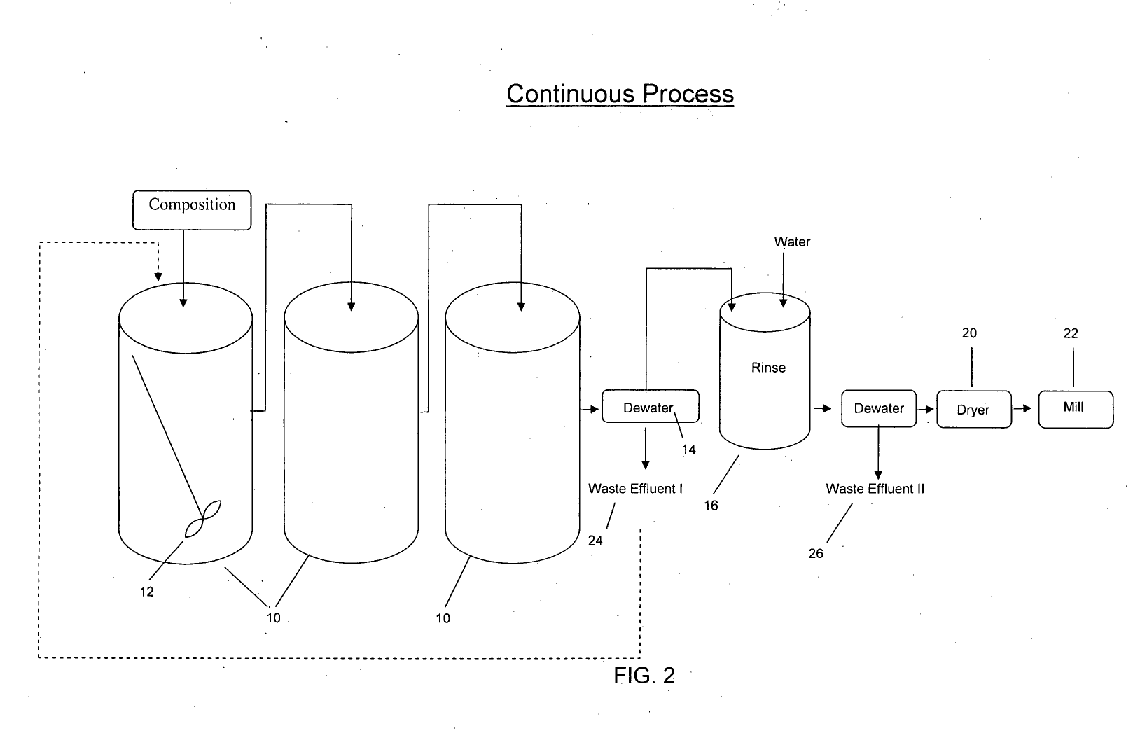

FIG. 2 illustrates an embodiment of the methods of the invention which is carried out in a continuous process (a series of reaction vessels are illustrated). Hot water, soy hulls, buffer and peroxide radical donor are placed in reactor 10 having a stirring element 12. As the digestion and bleaching process proceeds, the entire contents of reactor 10 moves through a series of reactors until the desired level of bleaching and digestion is achieved. The fiber is dewatered using a centrifuge or decanter 14 or other device for separating the fiber from the effluent. The bleached and digested fiber is rinsed in a rinse tank 16 to remove chemical residue from the digestion and bleaching step. The rinsed fiber is dewatered using a centrifuge or decanter 18 or other device for separating the fiber from the effluent. The dewatered fiber can optionally be dried in dryer 20. Optionally, the dried fiber can be ground in a mill 22 to yield a fiber of desired size depending upon the end use for the soy fiber. Waste effluent I 24 can optionally be recycled back into the reaction vessel. Waste effluent II 26 will be discarded.

As used herein, “agitation” is any mechanism to stir or agitate the compositions described herein. “Optional agitation” means that agitation can be used, or the compositions can be left to react without any agitation. The composition can be agitated during the bleaching and digestion step to ensure proper mixing and reaction. In general, in the continuous process, the composition of the first tank is agitated while the contents of the further processing tanks are not agitated. Any form of agitation to ensure proper mixing will work, and should be apparent to anyone skilled in the art. In a preferred embodiment, the second and subsequent reactions tanks are not agitated in order to maximize plug flow residence time.

In the methods of the present invention, in general, the percent by weight of solid (soy hulls and/or soy fiber) in the composition throughout the bleaching and digestion reaction (that is before isolating the soy fiber from the liquid composition) is above about 5%, above about 10%, above about 12% above about 13.5% above about 15% or above about 20%. In a continuous process, a mixture of water and buffer is fed into the tank 1 at about 55 gallons per minute, while soy hulls are fed at between 4000 and 4500 lbs/hr. This results in mixtures that have about 14% solids.

The compositions used in the methods of the present invention comprise soy hulls in an aqueous composition. The weight ratio of the soy hulls to water is adjusted to maximize bleaching and digestion. In general, the compositions for use in the methods of the present invention comprises between about 1 to about 50 parts by weight soy hulls to about 100 parts by weight of water, about 10 to about 30 parts by weight soy hulls to about 100 parts by weight of water or about 15 to about 25 parts by weight soy hulls to about 100 parts by weight of water. In one embodiment, the composition of the present invention comprises about 100 to 2000 lbs of soy hulls to about 30000 to 12000 lbs of water, 500 to 1200 lbs of soy hulls to about 40000 to 8000 lbs of water, about 1000 lbs of soy hulls to about 6000 lbs of water. In another embodiment, the present invention comprises about 190 lbs of hulls to about 1000 lbs water.

The soy hulls, water, buffer and peroxide radical donor are combined (bleaching and digestion take place) in the reaction vessel according to the methods of the present invention for a period of time sufficient to achieve a desired degree of bleaching and a desired degree of digestion. Preferably, the bleaching and digestion time are carried out for a period of between about 5 and about 25 hours, between about 8 and about 25 hours, between about 8 and about 20 hours, between about 8 and about 15 hours, or between about 8 and about 10 hours.

The pH of the reaction mixture should be controlled in the neutral pH range to provide optimal conditions for bleaching and digestion of the soy hulls for the purpose of controlling the quality of the final product. As used herein, a “pH regulating amount” of buffer is an amount effective to maintain the pH of the composition to achieve a desired degree of bleaching and digestion. In general, if the pH is outside the range of 5.5 to 8.5, the soy hulls do not bleach adequately and the soy fiber does not reach the desired brightness and color described herein. One of skill in the art can practice the invention outside the controlled neutral pH range and the invention is intended to embrace such embodiments. One method for controlling the pH range during the process is to monitor the pH of the composition as the reaction progresses, to maintain the pH within the desired range described herein. In one embodiment, the pH of the reaction is monitored at regular intervals. For example, the pH is monitored about every 5 hours, about every 2 hours, or about every 1 hour. In a particular embodiment, the pH is continuously monitored.

In preferred embodiments of the process, the pH of the composition suitable for use in the methods of the present invention is maintained during the bleaching and digestion from between about 5.5 about 8.5, about 6.0 to about 8.0, 6.5 to about 7.5, or about 6.8 and about 7.2. A typical reaction has an initial pH between 6.8 to 7.2 and a final pH between 6.0 and 6.4. Undesirable side reactions can be prevented by maintaining the final pH greater than 6.3.

Fluctuations in pH should be adjusted to maintain the appropriate pH conditions to achieve the desired degree of bleaching and digestion. The skilled person is readily aware of how to adjust the pH to maintain the desired pH range. For example, if the pH of the composition varies too low, for example below about pH 5.5, about pH 6.0, about pH 6.5 or about pH 6.8, additional base (strong alkali) is added in a batch mode or in the continuous mode the rate of addition of base/caustic (strong alkali is increased). If the pH varies too high above the target pH range, for example above about pH 8.5, about pH 8.0, about pH 7.5 or about pH 7.2, additional acid is added in the batch mode or in the continuous mode the rate of addition of base (strong alkali) is decreased. Based upon the pH ranges set forth herein, one skilled in the art will recognize how to adjust the pH to maintain appropriate pH conditions. When preparing a combination of acid and base for the buffer, combinations of a strong acid and strong base should be avoided. Any combination of weak base/strong acid or weak acid/strong base that provides the buffering pH range described herein will work in the methods of the invention.

In the reactions described herein, hydroxyl ions present in the compositions (that is those present in the buffer) are consumed by the bleaching and digestion steps. To ensure a consistent concentration of hydroxyl ions, hydroxyl ions are fed into the compositions in the first tank to equal the rate of hydroxyl consumption. The rate of continuous feed of hydroxyl can be determined by monitoring the pH. The preferred source of hydroxyl ions is provided from sodium hydroxide, potassium hydroxide or calcium hydroxide.

Alternatively, in the reactions described herein, the buffer is not consumed, and after dewatering and drying (isolation) of the soy fiber from the compositions the remaining buffer can be recycled into the composition of the first tank of the present invention. This recycling of the buffer leads to reduced initial costs for purchasing of solvent and reduces costs for effluent water treatment. It is noted that if the effluent from the first dewatering step is recycled, it will need to be recharged with sodium hydroxide to replenish the hydroxyl ions.

Buffers that are appropriate for use in the methods of the present invention, include but are not limited to: succinate and borax, phenyl acetate and HCl, acetate and acetic acid, succinate and succinic acid, 2-(N-morpholino)ethanesulfonic acid (MES), bis(2-hydroxyethyl)iminotris(hydroxymethyl)methane (BIS-TRIS), KH₂PO₄ and borax, N-(2-acetamido)-2-iminodiacetic acid (ADA), 2-[(2-amino-2-oxoethyl)amino]ethanesulfonic acid (ACES), piperizine-N,N′-bis(2-ethanesulfonic acid) (PIPES), 3-(N-morpholino)-2-hydroxypropanesulfonic acid (MOPSO), 1,3-bis[tris(hydroxymethyl)methylamino]propane (BIS-TRIS PROPANE), KH₂PO₄ and NaHPO₄, N,N-bis(2-hydroxyethyl)-2-aminoethanesulfonic acid (BES), 3-(N-morpholino)propanesulfonic acid (MOPS), N-(2-hydroxyethyl)piperazine-N′-(2-ethanesulfonic acid) (HEPES), N-tris(hydroxymethyl)methyl-2-aminoethanesulfonic acid) (TES), 3-[N,N-bis-(2-hydroxyethyl)amino]-2-hydroxypoppanesulfonic acid) (DIPSO), 3-[N-tris-(hydroxymethyl)methylamino]-2-hydroxypoppanesulfonic acid) (TAPSO), 5,5-diethylbarbiturate(veronal) and HCl, tris(hydroxymethyl)aminoethane (TRISMA), N-(2-hydroxyethyl)piperizine-N′-(2-hydroxypoppanesulfonic acid) (HEPPSO), piperizine-N,N′-bis(2-hydroxypropanesulfonic acid) (POPSO), triethanolamine (TEA), 4-(N-morpholino)butanesulfonic acid (MOBS), N-tris(hydroxymethyl)methylglycine (TRICINE), borax and HCl, N,N-bis(2-hydroxyethyl)glycine (BICINE), N-tris(hydroxymethyl)methyl-3-aminopropanesulfonic acid (TAPS), 3-[(1,1-diemthyl-2-hydroxyethyl)-2-hydroxypropanesulfonic acid (AMPSO), amminoa (aqueous) and NH₄Cl, Piperazine-1,4-bis(2-ethanesulphonic acid) (PIPES), succinic acid, succinic acid, free acid, phosphoric acid, imidazole, citric acid, N-(2-hyroxyethyl)piperazine-N-(3-propanesulfonic acid) (EPPS), GlycylGlycine (GLY-GLY), N-(2-Hydroxyethyl)piperazine-N′-(4-butanesulfonic acid) (HEPBS), 2-Amino-2-methyl-1,3-propanediol (AMPD), N-tris[Hydroxymethyl]methyl-4-aminobutane-sulfonic acid (TABS), tris (hydroxymethyl) aminomethane (TRIS), N-(2-hydroxyethyl)piperazine-N′-(3-propanesulfonic acid)(HEPPS), 3-cyclohexylaminopropane-1-sulfonic acid, TRIS acetate, salts and hydrates thereof, such as, for example, citric acid trisodium dihydrate TRIS hydrochloride succinic acid, disodium salt anhydrous, succinic acid, disodium salt hexahydrate, PIPES sodium salt, ADA monosodium salt, AMPSO sodium salt, HEPES sodium salt, HEPES low sodium salt, MES anhydrous, MES sodium salt MOPS sodium salt, MOPSO sodium salt, PIPES sodium salt, POPSO sodium salt, TAPS sodium salt, TES sodium salt, and combinations thereof, such as, HEPPES/EPPS.

Particularly suitable buffers for use in the methods of the present invention are selected from the group consisting of: 2-(N-morpholino)ethanesulfonic acid (MES), bis(2-hydroxyethyl)iminotris(hydroxymethyl)methane (BIS-TRIS), KH₂PO₄ and borax, N-(2-acetamido)-2-iminodiacetic acid (ADA), 2-[(2-amino-2-oxoethyl)amino]ethanesulfonic acid (ACES), piperizine-N,N′-bis(2-ethanesulfonic acid) (PIPES), 3-(N-morpholino)-2-hydroxypropanesulfonic acid (MOPSO), 1,3-bis[tris(hydroxymethyl)methylamino]propane (BIS-TRIS PROPANE), KH₂PO₄ and NaHPO₄, N,N-bis(2-hydroxyethyl)-2-aminoethanesulfonic acid (BES), 3-(N-morpholino)propanesulfonic acid (MOPS), N-(2-hydroxyethyl)piperazine-N′-(2-ethanesulfonic acid) (HEPES), N-tris(hydroxymethyl)methyl-2-aminoethanesulfonic acid) (TES), 3-[N,N-bis-(2-hydroxyethyl)amino]-2-hydroxypoppanesulfonic acid) (DIPSO), 3-[N-tris-(hydroxymethyl)methylamino]-2-hydroxypoppanesulfonic acid) (TAPSO), 5,5-diethylbarbiturate (veronal) and HCl, tris(hydroxymethyl)aminoethane (TRISMA), N-(2-hydroxyethyl)piperizine-N′-(2-hydroxypoppanesulfonic acid) (HEPPSO), piperizine-N,N′-bis(2-hydroxypropanesulfonic acid) (POPSO), triethanolamine (TEA), 4-(N-morpholino)butanesulfonic acid (MOBS), N-Piperazine-1,4-bis(2-ethanesulphonic acid) (PIPES), succinic acid, succinic acid, free acid, phosphoric acid, imidazole, citric acid, salts and hydrates thereof, such as, for example, citric acid trisodium dihydrate succinic acid, disodium salt anhydrous, succinic acid, disodium salt hexahydrate, PIPES sodium salt, and combinations thereof, such as, HEPPES/EPPS. Preferred buffers for use in the methods of the present invention comprise phosphoric acid and strong alkali (sodium hydroxide). In one embodiment, the buffer comprises sodium bicarbonate.

In another embodiment, the choice of buffer will be determined by the skilled person depending upon the product labeling of the soy fiber. For example, a bleached soy fiber produced by the processed of this invention could be labeled as being organic for human or animal consumption. The term “organic” is defined herein as any synthetic or nonsynthetic material or ingredient that is permitted by the USDA for incorporation into a food. See for example 7 CFR 205.605, 205.606. (National Organics Program; www.access.gpo.gov/nara/cfr/waisidx_{—}06/7cfr205_{—}06.html). In one embodiment where the bleached soy fiber is labeled as being an organic product, phosphoric acid should be avoided as a buffer because it is not certified in the U.S. as organic. For organic product labeling, one of skill in the art would be able to readily ascertain the buffers that are certified as organic.

The ratio of soy hulls to buffer, in general, effects the bleaching and digestion reactions of the methods described herein. In the compositions of the present invention, the ratio of soy hulls to buffer is typically about 1000 lbs of soy hulls to about 102 lbs 75% phosphoric acid and 150 lbs NaOH.

The concentration of buffers used in the present invention can also effect the bleaching and digestion reactions of the methods described herein. In the compositions of the present invention, the buffer concentration is typically from about 50 pounds to about 125 pounds of 75% phosphoric acid for 1,000 pounds soy hulls. Below this range of acid is permissible but the effects of bleaching and digestion are decreased. In one embodiment, the ratio of phosphoric acid to soy hulls is 10.2 lb 75% phosphoric acid to 100 lbs soy hulls.

The reaction rate for peroxide bleaching and removal of non-fibrous or non-cellulose components is a function of temperature. At low temperatures, the reaction is so slow that extended residence times are required which may be cost prohibitive. At very high temperatures (>210° F.) however, rates of unwanted side reactions that degrade the peroxide increase. The temperature of the composition during bleaching and digestion should be maintained to prevent unwanted side reactions and peroxide degradation. It has been discovered that when the soy hull slurry pH drops below pH 6.4 at temperatures greater than 180° F., undesirable reactions turn the slurry to a reddish brown color, accompanied by the rapid decomposition of peroxide. In preferred embodiments, the temperature of the composition during the bleaching and digestion step should be maintained between about 150° F. and about 210° F., between about 160° F. and about 200° F., between about 165° F. and about 185° F., or between about 160° F. and about 190° F. In preferred embodiments, it is not necessary to control the temperature during any other part of the process as long as the pH is maintained above 6.4. It is noted that at pH greater than 9 will result in rapid peroxide degradation in the soy hulls and the alkali extraction of cellulose. In general, the exotherm generated from peroxide radical donor and buffer, in combination with the soy hulls, maintains the reaction temperature without the need for any external heating elements.

As used herein a “peroxide radical donor” is a compound capable of supplying peroxide (O²⁻) ions when added to the compositions of the present invention. That is a “peroxide radical donor” is a source of peroxide ions. The peroxide radical donor suitable for use in the method of the present invention in general, also serves to digest the non-fibrous components of the soy hulls in the composites for use in the method of the present invention. The peroxide radical donor removes non-fibrous or non-cellulosic components from the soy hulls to produce a soy fiber with a high total dietary fiber content. “Non-fibrous materials”, “non-fibrous components” and “non-cellulosic” as used herein, includes but is not limited to, pectins, fats and oils, gums, lignins, proteins and starch. In the soy fiber produced by the methods of the present invention, typically between about 50% and about 100% of the non-fibrous or non-cellulosic components are removed from the original soy hulls.

Sources of peroxide ions include but are not limited to, sodium peroxide, barium peroxide, benzoyl peroxide, chlorobenzoyl peroxide, cumene hydroperoxide, diacetyl peroxide, 2,4-dichlorobenzoyl peroxide, dicumyl peroxide, diisopropylbenzene hydroperoxide, di(4-methylbenzoyl)peroxide, lauroyl peroxide, lauryl peroxide, p-menthane hydroperoxide, methyl ethyl ketone peroxide, tert-butyl hydroperoxide, tert-butyl peroxide, (1,1,4,4-tetramethyltetramethylene)bis(tert-butyl peroxide), acetone peroxides, calcium peroxide, hydrogen peroxide, lecithin benzoyl peroxide modified, lecithin hydrogen peroxide modified, and combinations thereof. Particular peroxide radical donors are selected from the group consisting of sodium peroxide, benzoyl peroxide, calcium peroxide and hydrogen peroxide.

A suitable peroxide radical donor, in general, bleaches the soy hulls in the methods of the present invention. As used herein, an amount of peroxide radical donor effective to bleach the soy hulls in the methods of the present invention, is an amount sufficient to bleach the soy hulls to a brightness index (L) of between about 80 and about 100, between about 87 and about 94, or between about 90 and about 94 and the color (b) is between about 5 and about 15, between about 7 and about 13 or between about 8 and about 11 (further information about L and b is described in “Hunter Lab Color Scale”, Insight on Color Aug. 1-15, 1996, Vol. 8 No. 9 page 1-4, the entire contents of which are incorporated herein by reference).

As used herein, the ratio of soy hulls to peroxide radical donor in the methods of the present invention is 1000 lbs soy hulls to 190 lbs of 50% H₂O₂. Generally, for every 1000 lbs soy hulls, from about 100 to about 300 lbs 50% of H₂O₂ would be an appropriate range. As the peroxide level is reduced, the resultant soy fiber product will have a reduced brightness and/or higher b value (increased yellow color) and a lower TDF.

The bleached fiber can be used in its wet form for a food ingredient or it can be optionally dried. Any method of drying the bleached fiber can be used, provided that it does not discolor or degrade the fiber. Air drying is preferred. Suitable dewatering equipment includes centrifugation equipment like a centrifuge or a decanter, filtering equipment like a belt filter, squeezing equipment like a belt press. Suitable drying equipment includes box dryers, flash dryers, drum dryers, spray dryers, and freeze dryers, which will be obvious to anyone skilled in the art.

In an embodiment, the dewatering and rinsing steps are performed together using equipment that is designed to accomplish both processes. For example, the belt filter (Bird Pannevis Filter, Bird Manufacturing Company) has a built-in wash capability. The soy fiber that has been dewatered and rinsed can be collected as a cake that can be used directly in a food application, without drying the cake. This can reduce costs by eliminating the need for drying. The cake can be optionally ground to reduce the particle size of the soy fiber.

The skilled person will recognize that the soy fiber cake, without having been dried, can be incorporated into a food, provided that the buffer and the residual peroxide do not negatively impact the food. The food manufacturer may need to adjust these levels prior to use or may need to destroy the peroxide activity, for example enzymatically, prior to use. Residual peroxide will act as an effective preservative to minimize and/or prevent microbial growth during shipping and storage, if not used immediately.

The dried fiber can optionally be milled to provide a desired particle size and homogeneity to the final product. The size of the fiber particles will influence their degree of bleaching as determined by the brightness and color scale, as described above. Preferably, the size of the fiber will be less than about 200 μm, preferably less than about 100 μm, or preferably less than about 50 μm. The particle size can be as small as 5 μm but it can be less depending upon the desired end use. The size of the particles can impact the organoleptic properties of the food in which it is incorporated. One of skill in the art can readily ascertain the particle size that is desirable, based upon the color one wishes to achieve and the type of food. For example, a fiber that has particles that are too large can render the baked good gritty tasting and it may affect the ability of the dough to raise adequately.

The process of the invention produces a soy fiber that is both bleached and highly concentrated. During the digestion, non-fibrous or non-cellulosic material is removed from the soy fiber. Thus, the bleached soy fiber is essentially free of non-fibrous materials or components, such as but not limited to pectins, fats, gums, lignins, proteins and starch. The total yield of soy fiber from the soy hulls is between about 60% and about 20%, between about 55% and about 30%, between about 50% and about 40% or between about 48% and about 45% of the weight of the soy hulls.

The product can be classified as a high dietary fiber using the methodology and definitions currently recognized by AOAC, e.g., AOAC 991.43 which teachings are incorporated herein by reference in their entirety. As used herein, a “high total dietary fiber” is the total amount of fiber in the soy fiber produced by the methods of the present invention. Typically, the high total dietary fiber present in the soy fiber produced by the methods of the present invention is between about 30 and about 50%, between about 43 and about 48%, between about 50 and 100%, or between about 80 and 95% of the weight of the total soy fiber.

The bleached soy fibers produced by the methods of the present invention are white. The degree of whiteness or brightness for the final product of the process described herein can be determined using a brightness index (“Hunter Lab Color Scale”, Insight on Color, Aug. 1-15, 1996, Vol. 8 No. 9 page 1-4). Preferably, the bleached soy fiber can have a brightness index (L) of between about 80 and about 100, between about 87 and about 94, or between about 90 and about 94 and the color (b) is between about 5 and about 15, between about 7 and about 13, or between about 8 and about 11.

The soy fiber produced by the methods of the present invention typically comprises one or more of the following characteristics:

a) less than about 20% protein, about 10% protein or about 5% protein;

b) a brightness index (L) between about 80 and about 100, between about 87 and about 94, or between about 90 and about 94;

c) a color (b) between about 5 and about 15, between about 7 and about 13 or between about 8 and about 11;

d) total yield of soy fiber from the soy hulls between about 60% and about 20%, between about 55% and about 30%, between about 50% and about 40% or between about 48% and about 45% of the weight of the soy hulls; and

e) a total dietary fiber content between about 30 and about 50%, between about 43 and about 48%, between about 50 and 100% or between about 80 and 95% of the weight of the total soy fiber:

The soy fibers, in general, can be used as a food additive in, for example, bakery products, such as, bread without causing any signification discoloration of the bread. The primary intended uses are in baked goods like bread, muffins, extruded foods like cereal, beverages fortified with dietary fiber. The soy fiber of the present invention can be used to fortify foods with a high dietary fiber source that is inert and has little or no off-flavors that are imparted to the food. The soy fiber can be easily selected for particle size that does not impart a gritty or undesirable texture to the food product. Because the total dietary fiber content of the bleached soy fiber of the invention is high, a food manufacturer does not have to add large quantities of the fiber. The soy fiber of the present invention can be easily incorporated into a food product by, for example, adding it directly to the dough to fortify it with dietary fiber. Similar fortification techniques using the soy fiber will be obvious to a food manufacturer skilled in the art.

### EXEMPLIFICATION

### Example 1

### Soy Fiber: Continuous Mode

For continuous mode processing, chemicals and water were fed into a tank at the following rates: the caustic as sodium hydroxide at 40 gph; hydrogen peroxide at 60 gph; phosphoric acid at 22 gph; process water at 190° F. at 35 gpm. Soy bean hulls were fed at a rate of 5000 lbs per hour. The agitator on the tank was turned on and the recycle line to pump slurry from the bottom of the tank to the top of tank was also turned on.

The pH of the tank was maintained at between 6.8 and 7.2. If the pH dropped below 6.8, the caustic feed rate was increased in small increments and the pH monitored every 30 minutes. If the pH went above 7.2, the caustic feed rate was decreased in small increments and the pH monitored every 30 minutes. When the pH was in the desired range (between 6.8 and 7.2), the pH was monitored every 60 minutes.

The volume of solids in the tank was monitored to ensure that the volume of solids remained above 13.5%. If the volume was below 13.5%, the process water feed rate was varied as necessary.

Once the composition in the tank was established at 70%, the recycle line was changed to transfer to a second tank. No agitator was turned on in this second tank in order to ensure undisturbed plug flow through the tank. No chemicals were added to the second tank.

After the composition level in the second tank reached 85%, the transfer pump from the second tank to a third tank was switched on. The 85% level target was maintained in the second tank. No agitator was turned on in the third tank. No chemicals were added to the third tank. After the quantity level in the third tank reached 80%, the slurry was transferred to a decanter (Sharples Model 5000) that uses centrifugal force to separate the insoluble material from the liquid. The soy fiber cake from the decanter was resuspended in water in a separate tank, and the slurry was centrifuged using a second decanter (Sharples Model 60000) to purify the cake. The cake was dried in a gas-fired primary dryer/mill (Jacobson Model 48H, Air Swept Pulverizer with combined function of drying and milling) for forced air convection drying, followed by another gas-fired secondary dryer/mill (Jacobson Model 48H, Air Swept Pulverizer with combined function of drying and milling).

### Example 2

### Effects of Time on Slurry Brightness and Slurry Color

After filling the tanks with a mixture of hot water, soy bean hulls, sodium hydroxide, phosphoric acid and hydrogen peroxide (total time to fill the tanks was approximately 4.5 hours), slurry was sampled approximately every hour to measure brightness L and color b of the slurry. The conditions of Example 1 were followed.

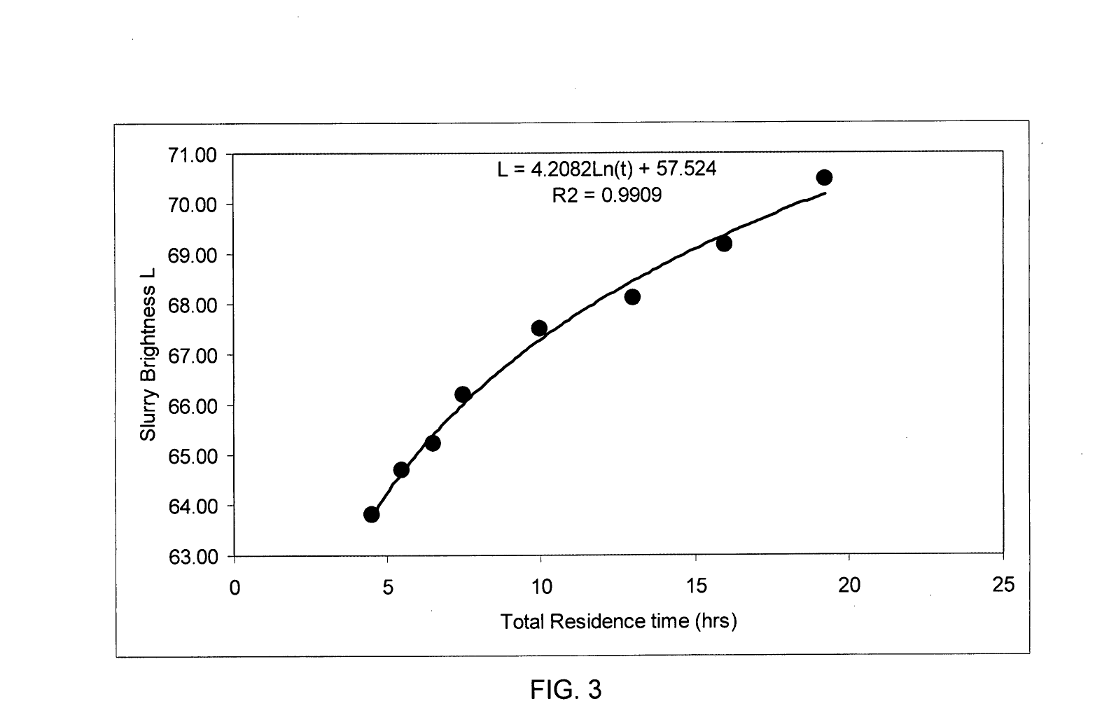

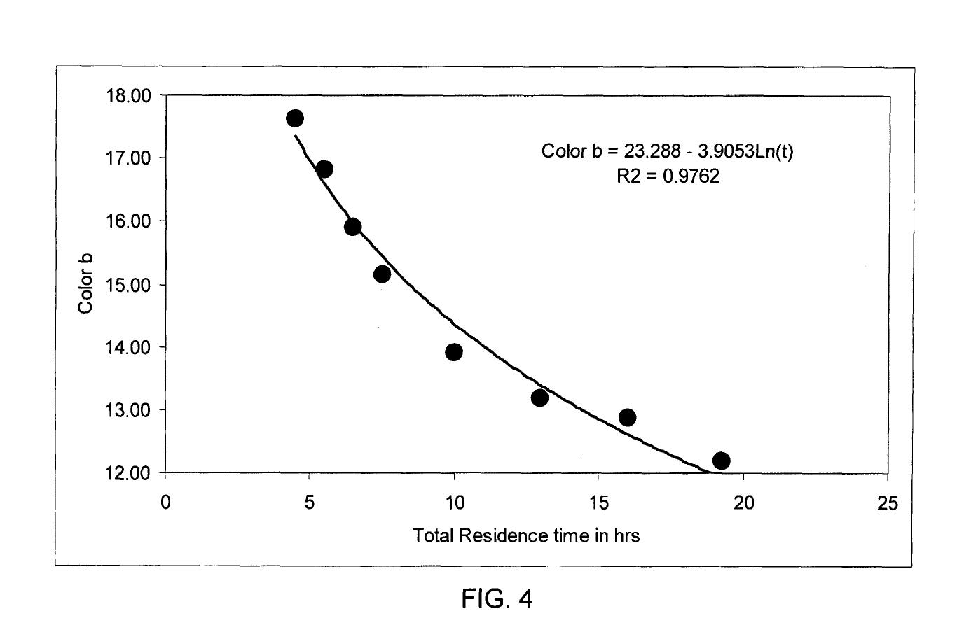

The results are shown in FIGS. 3 and 4. The brightness L and color b of the slurry is not representative of the brightness L and the color b of the finished product which will be brighter and lighter than the slurry. However, a brighter and lighter slurry results in a brighter and lighter finished product.

### Example 3

Different parameters were tested to determine the effective methods for bleaching. All tests were performed by dispersing soy hulls in hot water (about 190° F.) and buffer to make a 10 to 20% solids slurry, followed by the addition of hydrogen peroxide. The reaction was allowed to proceed for 8 hours. It is important to note that color and brightness results are, in part, a function of particle size. The pilot mill fiber is finer in particle size and will result in brighter fiber than fiber ground using the coffee grinder. The parameters tested and the results of the tests were as follows:
A. Bleaching using peroxide at pH 7.0
   Soy hulls (51 grams), 50% NaOH (19.0 grams), 85% phosphoric acid (13.6 grams), 50 H₂O₂ (10.0 grams), initial pH=7.17. pH dropped to 6.8 in 7 hours. The slurry was centrifuged using a countertop centrifuge to dewater the fiber. The fiber was spread thin and allowed to air dry. The dried fiber was milled using a coffee grinder. The process yielded a bleached soy fiber having a brightness L of 91.8, color b of 6.8, protein content of 4% and TDF>90%. These results indicate that soy hulls can be bleached using peroxide if the slurry is buffered at near pH 7.0.
B. Insufficient bleaching in absence of buffer
   Soy hulls (50 grams), 50% NaOH (1.2 grams), phosphoric acid (0 grams), 50% H₂O₂ (10.7 g), initial pH=7.60. pH dropped to 5.75 in 4 hours. The slurry was centrifuged using a countertop centrifuge to dewater the fiber. The fiber was spread thin and allowed to air dry. The dried fiber was milled using a coffee grinder. The material was coarser than the previous example A, since a lesser bleached/digested material has a greater particle hardness. This in turn resulted in a coarser particle size when ground using the same mill. The process yielded a soy fiber having a brightness L of 82.7, color b of 12.1, protein content of 7.6% and TDF<89%. These results indicate that there is insufficient bleaching if no buffer is used.
C. Variation in starting pH affects bleaching
   Soy hulls (32 lbs), 50% NaOH (2900 grams), 85% phosphoric acid (1563 grams), 50% H₂O₂ (2800 grams), initial pH=8.0+, final pH=7.3. The slurry was centrifuged (Bird Centrifuge PPM6000 Serial No. OB5222) using the decanter, dried in a dryer (Fluid Bed Dryer, Lab-line Instruments Model 23852) and ground using a Pilot Mill (Pulverizer Mill, Schultz-O'Neill Co. Model 12HSON47126). The process yielded a soy fiber having a brightness L of 91.5, color b of 10.0, protein content of 4.0% and TDF>90%. These results indicate that a starting pH of 7.2 gives better brightness results than a starting pH of 8.0 or higher. See example D below.
D. Variation in starting pH affects bleaching
   Soy hulls (47 lbs), 50% NaOH (2660 grams), 85% phosphoric acid (1750 grams), 50% H2O2 (3720 grams), initial pH=7.2, final pH=6.3. The slurry was centrifuged (Bird Centrifuge PPM6000 Serial No. OB5222) using the decanter, dried in a dryer (Fluid Bed Dryer, Lab-line Instruments Model 23852) and ground using a Pilot Mill (Pulverizer Mill, Schultz-O'Neill Co. Model 12HSON47126). The process yielded a brightness L of 93.3, color b of 7.5, protein content of 4.3% and TDF>90%. These results indicate that a starting pH of 7.2 gives better brightness results than a starting pH of 8.0 (shown in example C above) or higher.
E. Variation in pH affects brightness of the soy fiber—No buffer
   Soy hull (100 grams), 50% NaOH (0 grams), 85% phosphoric acid (0 grams), 50% H₂O₂ (17.5 grams), initial pH=6.2, final pH=4.5. The slurry was centrifuged using a countertop centrifuge to dewater the fiber. The fiber was spread thin and allowed to air dry. The dried fiber was not milled. Visual observations showed that example F (below) was brighter than example E, but not as bright as example D (above).
F. Variation in pH affects brightness of the soy fiber—Buffer range not tightly controlled
   Soy hull (100 grams), 50% NaOH (6.2 grams), 85% phosphoric acid (4 grams), 50% H₂O₂ (17.7 grams), initial pH=7.25, final pH=5.8. The slurry was centrifuged using a countertop centrifuge to dewater the fiber. The fiber was spread thin and allowed to air dry. The dried fiber was not milled. Visual observations showed that example G (below) was brighter than example E, but not as bright as example D (above).
G. Reduction in amount of buffer affects degree of bleaching
   Soy hull (40 lbs), 50% NaOH (1370 grams), 85% phosphoric acid (743 grams), 50% H₂O₂ (3150 grams), initial pH=7.6, final pH=6.6. The slurry was centrifuged (Bird Centrifuge PPM6000 Serial No. OB5222) using the decanter, dried in a dryer (Fluid Bed Dryer, Lab-line Instruments Model 23852) and ground using a Pilot Mill (Pulverizer Mill, Schultz-O'Neill Co. Model 12HSON47126). The process yielded soy fiber having a brightness L of 90.1, color b of 11.3 and protein content of 5.3%. These results indicate that halving the amount of buffer resulted in moderate bleaching.
H. Recycling of effluent
   Soy hull (29 lbs), 50% NaOH (1461 grams), 85% phosphoric acid (542 grams), 50% H₂O₂ (1860 grams), initial pH=7.0, final pH=6.2. Effluent was used instead of hot water in this test to emulate a recycling scenario. Thus, the starting temperature was lower than in the previously described tests. The heating element in the tank was not switched on to prevent overheating. The process yielded soy fiber having a brightness L of 92.1, color b of 8.7 and protein content of 3.5%. These results indicate that slurry bleached in effluent produces a desirable end product.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for making a bleached soy fiber, comprising:
a) combining soy hulls with water, an amount of peroxide radical donor effective to bleach the soy hulls and a pH regulating amount of buffer, to form a composition having a pH from about 5.5 to about 8.5;
b) isolating bleached soy fiber from the composition to give a yield of between 10 and 50% of bleached soy fiber; and
c) optionally dewatering and drying the bleached soy fiber.

2. The method of claim 1, wherein the pH of the composition in step a) is from about 6.0 to about 8.0.

3. The method of claim 2, wherein the pH of the composition in step a) is from about 6.5 to about 7.5.

4. The method of claim 3, wherein the pH of the composition in step a) is from about 6.8 to about 7.2.

5. The method of claim 1, wherein the composition of step a) comprises between about 1 to about 50 parts by weight soy hulls to about 100 parts by weight of water.

6. The method of claim 5, wherein the composition of step a) comprises between about 10 to about 30 parts by weight soy hulls to about 100 parts by weight of water.

7. The method of claim 6, wherein the composition of step a) comprises between about 15 to about 25 parts by weight soy hulls to about 100 parts by weight of water.

8. The method of claim 1, wherein the temperature of step a) is between about 150 and about 210° F.

9. The method of claim 8, wherein the temperature of step a) is between about 160 and about 200° F.

10. The method of claim 9, wherein the temperature of step a) is between about 165 and about 185° F.

11. The method of claim 1, wherein the total yield of soy fiber is between about 30 and about 50%.

12. The method of claim 11, wherein the total yield of soy fiber is between about 43 and about 48%.

13. The method of claim 1, wherein the total dietary fiber of the soy fiber is between about 50 and 100%.

14. The method of claim 13, wherein the total dietary fiber of the soy fiber is between about 80 and 95%.

15. The method of claim 1, wherein the brightness (L) of the soy fiber is between about 80 and 100 and the color (b) is between 5 and 15.

16. The method of claim 15, wherein the brightness (L) is between 87 and 94 and the color (b) is between 7 and 13.

17. The method of claim 16, where the brightness (L) is between 90 and 94 and the color (b) is between 8 and 11.

18. The method of claim 1, wherein the buffer is strong alkali and weak acid.

19. The method of claim 18, wherein the weak acid is initially added prior to the strong alkali.

20. The method of claim 19, wherein the strong alkali is sodium hydroxide, potassium hydroxide or calcium hydroxide.

21. The method of claim 20, wherein the pH in step a) is maintained at about 6.8 to about 7.2 by the increase or decrease in the rate of addition of sodium hydroxide.

22. The method of claim 1, wherein the peroxide radical donor is selected from the group consisting of sodium peroxide, benzoyl peroxide, calcium peroxide, hydrogen peroxide and combinations thereof.

23. The method of claim 1, wherein the soy hulls, water, buffer and peroxide radical donor are added to the composition of step a) on a batch or continuous basis.

24. The method of claim 1, wherein the soy hulls, water, buffer and peroxide radical donor in step a) are combined for between about 5 and about 25 hours.

25. The method of claim 24, wherein the soy hulls, water, phosphoric acid, hydrogen peroxide and strong alkali in step a) are combined for between about 8 and about 25 hours.

26. The method of claim 1, wherein between about 50% and 100% of the non-fiber components are removed from the soy hulls in step a).

27. The method of claim 29, wherein the non-fiber components are selected from the group consisting of pectins, gums, protein and combinations thereof.

28. The method of claim 27, wherein the soy fiber of step c) comprises less than about 10% protein.

29. The method of claim 28, wherein the soy fiber of step c) comprises less than about 5% protein.

30. The method of claim 1, wherein the buffer removed in the dewatering step c) is recycled into the composition of step a).

31. A method for making a bleached soy fiber, comprising:
a) combining soy hulls with water and a pH regulating amount of buffer to form a composition having a pH from about 5.5 to about 8.5;
b) adding an amount of peroxide radical donor effective to bleach the soy hulls to the composition;
c) isolating bleached soy fiber from the composition to give a yield of between 10 and 50% of bleached soy fiber; and
c) optionally dewatering and drying the bleached soy fiber.

32. A method for making bleached soy fiber, comprising:
a) combining between about 1 to about 50 parts by weight soy hulls with about 100 parts by weight water, with an amount of peroxide radical donor effective to bleach the soy hulls and a pH regulating amount buffer, to form a composition having a pH from about 5.5 to 8.5;
b) isolating bleached soy fiber from the composition; and
c) optionally dewatering and drying the bleached soy fiber.

33. The method of claim 18, wherein the weak acid is phosphoric acid.
